(19) United States
(12) Patent Application Publication
(10) Pub. No.: US 2024/0187916 A1
(43) Pub. Date: Jun. 6, 2024

(54) CONFIGURED GRANT ENHANCEMENT

(71) Applicant: Apple Inc., Cupertino, CA (US)

(72) Inventors: Fangli Xu, Beijing (CN); Dawei Zhang, Saratoga, CA (US); Haijing Hu, Los Gatos, CA (US); Murtaza A. Shikari, Mountain View, CA (US); Ralf Rossbach, Munich (DE); Sarma V. Vangala, Campbell, CA (US); Srinivasan Nimmala, San Jose, CA (US)

(73) Assignee: Apple Inc., Cupertino, CA (US)

(21) Appl. No.: 17/796,634

(22) PCT Filed: Sep. 3, 2021
(86) PCT No.: PCT/CN2021/116533

§ 371 Date: Jul. 29, 2022

(51) Int. Cl. H04W 28/02; H04W 72/1268

(52) U.S. Cl. CPC H04W 28/0268; H04W 28/0278; H04W 72/1268

(57) ABSTRACT

Provided is a method for a network, that includes: determining quality of service (QoS) information for a plurality of data flows with different QoS attributes, transmitting, to a user equipment (UE), a configuration message generated based on the QoS information, wherein the configuration message includes configuration information for at least one configured grant (CG); and receiving, from the UE based on the at least one CG, uplink data based on the plurality of data flows.

### TECHNICAL FIELD

This application relates generally to wireless communication systems, and more specifically to enhancement for configured grant.

### BACKGROUND

Wireless mobile communication technology uses various standards and protocols to transmit data between a base station and a wireless mobile device. Wireless communication system standards and protocols can include the 3rd Generation Partnership Project (3GPP) long term evolution (LTE); fifth-generation (5G) 3GPP new radio (NR) standard, the Institute of Electrical and Electronics Engineers (IEEE) 802.16 standard, which is commonly known to industry groups as worldwide interoperability for microwave access (WiMAX); and the IEEE 802.11 standard for wireless local area networks (WLAN), which is commonly known to industry groups as Wi-Fi. In 3GPP radio access networks (RANs) in LTE systems, the base station can include a RAN Node such as an Evolved Universal Terrestrial Radio Access Network (E-UTRAN) Node B (also commonly denoted as evolved Node B, enhanced Node B, eNodeB, or eNB) and/or Radio Network Controller (RNC) in an E-UTRAN, which communicate with a wireless communication device, known as user equipment (UE). In fifth generation (5G) wireless RANs. RAN Nodes can include a 5G Node, new radio (NR) node or g Node B (gNB), which communicate with a wireless communication dev ice, also known as user equipment (UE).

### SUMMARY

According to an aspect of the present disclosure, a method for a network is provided that comprises determining quality of service (QoS) information for a plurality of data flows with different QoS attributes, transmitting, to a user equipment (UE), a configuration message generated based on the QoS information, wherein the configuration message includes configuration information for at least one configured grant (CG); and receiving, from the UE based on the at least one CG, uplink data based on the plurality of data flows.

According to an aspect of the present disclosure, a method for a user equipment is provided that comprises receiving, from a network, a configuration message, wherein the configuration message includes configuration information for at least one configured grant (CG) and is determined based on quality of service (QoS) information for a plurality of data flows with different QoS attributes; and generating, for transmission to the network based on the at least one CG, uplink data based on the plurality of data flows.

According to an aspect of the present disclosure, an apparatus for a user equipment (UE) is provided that comprises: one or more processors configured to perform steps of the above-mentioned method for the user equipment.

According to an aspect of the present disclosure, an apparatus for a network that comprises: one or more processors configured to perform steps of the above-mentioned method for the network.

According to an aspect of the present disclosure, it is provided a computer readable medium having computer programs stored thereon which, when executed by one or more processors, cause an apparatus to perform steps of the above-mentioned method.

According to an aspect of the present disclosure, it is provided a computer program product comprising computer programs which, when executed by one or more processors, cause an apparatus to perform steps of the above-mentioned method.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure.

FIG. 1 is a block diagram of a system including a base station and a user equipment (UE) in accordance with some embodiments.

FIG. 2 illustrates a flowchart for an exemplary method for a network in accordance with some embodiments.

FIG. 3 illustrates a flowchart for an exemplary method for a user device in accordance with some embodiments.

FIG. 4 illustrates a communication exchange in connection with determination of the suggestion information in accordance with some embodiments of the present disclosure.

FIG. 5 illustrates another communication exchange in connection with determination of the suggestion information in accordance with some embodiments of the present disclosure.

FIG. 6 illustrates yet another communication exchange in connection with determination of the suggestion information in accordance with some embodiments of the present disclosure.

FIG. 7 illustrates a communication exchange in connection with uplink transmission based on the CGs in accordance with some embodiments of the present disclosure.

FIG. 8A illustrates another communication exchange in connection with uplink transmission based on the CGs in accordance with some embodiments of the present disclosure.

FIG. 8B illustrates an exemplary Medium Access Control (MAC)-Control Element (CE) in accordance with some embodiments of the present disclosure.

FIG. 9 illustrates yet another communication exchange in connection with uplink transmission based on the CGs in accordance with some embodiments of the present disclosure.

FIG. 10 illustrates yet another communication exchange in connection with uplink transmission based on the CGs in accordance with some embodiments of the present disclosure.

FIG. 11 illustrates yet another communication exchange in connection with uplink transmission based on the CGs in accordance with some embodiments of the present disclosure.

FIG. 12 illustrates yet another communication exchange in connection with uplink transmission based on the CGs in accordance with some embodiments of the present disclosure.

FIG. 13 illustrates an exemplary block diagram of an apparatus for a network in accordance with some embodiments.

FIG. 14 illustrates an exemplary block diagram of an apparatus for UE in accordance with some embodiments.

FIG. 15 illustrates example components of a device 1500 in accordance with some embodiments.

FIG. 16 illustrates example interfaces of baseband circuitry in accordance with some embodiments.

FIG. 17 illustrates components in accordance with some embodiments.

FIG. 18 illustrates an architecture of a wireless network in accordance with some embodiments.

### DETAILED DESCRIPTION

In the present disclosure, a “base station” can include a RAN Node such as an Evolved Universal Terrestrial Radio Access Network (E-UTRAN) Node B (also commonly denoted as evolved Node B, enhanced Node B, eNodeB, or eNB) and/or Radio Network Controller (RNC), and/or a 5G Node, new radio (NR) node or g Node B (gNB), which communicate with a wireless communication device, also known as user equipment (UE). Although some examples may be described with reference to any of E-UTRAN Node B, an eNB, an RNC and/or a gNB, such devices may be replaced with any type of base station.

Carrier aggregation is a technology according to which multiple carrier signals operating on different frequencies may be used to carry communications for a single UE, thus increasing the bandwidth available to a single device. In some aspects, carrier aggregation may be used where one or more component carriers operate on unlicensed frequencies.

In order to increase the bandwidth and thus increasing the bitrate, a user equipment (UE) may be connected to more than one serving cell. In New Radio (NR), one serving cell may be designated as a primary cell (PCell), while some other cells may be secondary cells (SCells). In some cases, a PCell and SCells for UE may correspond to (supported by) a same base station. In some other cases, PCell and SCells may correspond to (supported by) different base stations.

In wireless communications, every frequency band has a primary component carrier which is called a primary cell (PCell) and others are called secondary cell (SCell). Whenever necessary, the SCell can be activated for data transmission.

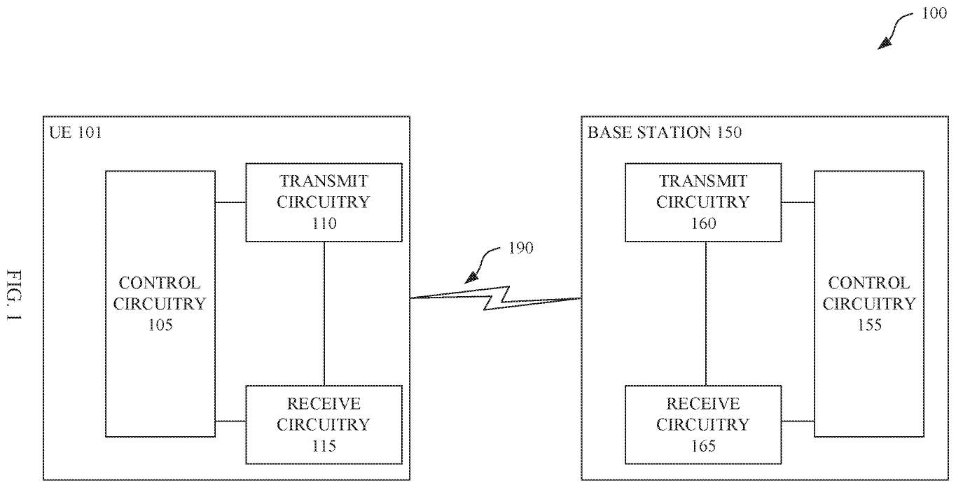

FIG. 1 illustrates a wireless network 100, in accordance with some embodiments. The wireless network 100 includes a UE 101 and a base station 150 connected via an air interface 190.

The UE 101 and any other UE in the system may be, for example, laptop computers, smartphones, tablet computers, printers, machine-type devices such as smart meters or specialized devices for healthcare monitoring, remote security surveillance, an intelligent transportation system, or any other wireless devices with or without a user interface. The base station 150 provides network connectivity to a broader network (not shown) to the UE 101 via the air interface 190 in a base station service area provided by the base station 150. In some embodiments, such a broader network may be a wide area network operated by a cellular network provider, or may be the Internet. Each base station service area associated with the base station 150 is supported by antennas integrated with the base station 150. The service areas am divided into a number of sectors associated with certain antennas. Such sectors may be physically associated with fixed antennas or may be assigned to a physical area with tunable antennas or antenna settings adjustable in a beamforming process used to direct a signal to a particular sector. One embodiment of the base station 150, for example, includes three sectors each covering a 120-degree area with an array of antennas directed to each sector to provide 360-degree coverage around the base station 150.

The UE 101 includes control circuitry 105 coupled with transmit circuitry 110 and receive circuitry 115. The transmit circuitry 110 and receive circuitry 115 may each be coupled with one or more antennas. The control circuitry 105 may be adapted to perform operations associated with MTC. In some embodiments, the control circuitry 105 of the UE 101 may perform calculations or may initiate measurements associated with the air interface 190 to determine a channel quality of the available connection to the base station 150. These calculations may be performed in conjunction with control circuity 155 of the base station 150. The transmit circuitry 110 and receive circuitry 115 may be adapted to transmit and receive data, respectively. The control circuitry 105 may be adapted or configured to perform various operations such as those described elsewhere in this disclosure related to a UE. The transmit circuitry 110 may transmit a plurality of multiplexed uplink physical channels. The plurality of uplink physical channels may be multiplexed according to time division multiplexing (TDM) or frequency division multiplexing (FDM). The transmit circuitry 110 may be configured to receive block data from the control circuitry 105 for transmission across the air interface 190. Similarly, the receive circuitry 115 may receive a plurality of multiplexed downlink physical channels from the air interface 190 and relay the physical channels to the control circuitry 105. The uplink and downlink physical channels may be multiplexed according to TDM or FDM The transmit circuitry 110 and the receive circuitry 115 may transmit and receive both control data and content data (e.g. messages, images, video, et cetera) structured within data blocks that are carried by the physical channels.

FIG. 1 also illustrates the base station 1541, in accordance with various embodiments. The base station 150 circuitry may include control circuitry 155 coupled with transmit circuitry 160 and receive circuitry 165. The transmit circuitry 160 and receive circuitry 165 may each be coupled with one or more antennas that may be used to enable communications via the air interface 190.

The control circuitry 155 may be adapted to perform operations associated with MTC The transmit circuitry 160 and receive circuitry 165 may be adapted to transmit and receive data, respectively, within a narrow system bandwidth that is narrower than a standard bandwidth structured for person to person communication. In some embodiments, for example, a transmission bandwidth may be set at or near 1.4 MHz. In other embodiments, other bandwidths may be used. The control circuitry 155 may perform various operations such as those described elsewhere in this disclosure related to a base station.

Within the narrow system bandwidth, the transmit circuitry 160 may transmit a plurality of multiplexed downlink physical channels. The plurality of downlink physical channels may be multiplexed according to TDM or FDM. The transmit circuitry 160 may transmit the plurality of multiplexed downlink physical channels in a downlink super-frame that is comprised of a plurality of downlink subframes.

Within the narrow system bandwidth, the receive circuitry 165 may receive a plurality of multiplexed uplink physical channels. The plurality of uplink physical channels may be multiplexed according to TDM or FDM The receive circuitry 165 may receive the plurality of multiplexed uplink physical channels in an uplink super-frame that is comprised of a plurality of uplink subframes.

As described further below, the control circuitry 105 and 155 may be involved with measurement of a channel quality for the air interface 190. The channel quality may, for example, be based on physical obstructions between the UE 101 and the base station 150, electromagnetic signal interference from other sources, reflections or indirect paths between the UE 101 and the base station 150, or other such sources of signal noise. Based on the channel quality, a block of data may be scheduled to be retransmitted multiple times, such that the transmit circuitry 110 may transmit copies of the same data multiple times and the receive circuitry 115 may receive multiple copies of the same data multiple times.

The IE and various base stations (for example, base stations that support all kinds of serving cells including PCell and SCell, or base stations that act as the network device of PCell or SCell for communicating with the UE) described in the following embodiments may be implemented by the UE 101 and the base station 150 described in FIG. 1.

Configured grant (CG) may be use to satisfy periodical data transmission or be used to satisfy services with low latency requirement Based on a configured grant indicated in the control message received from the network, the UE may send uplink data in each occasion configured for the CG.

The data flows to be transmitted may have different QoS attributes. For example, the data flows may have different priorities, different transport block (TB) sizes, etc. It will be advantageous if network scheduling could be determined based on the different QoS attributes for different data flows.

Current configuration manner for a configured grant may support association between a particular logical channel (LCH) and the configured grant. For example, a first logical channel (LCH 1) may be configured to be transmitted based on a first configured grant (CG 1), and a second logical channel (LCH 2) which is different from LCH 1 may be configured to be transmitted based on a second configured grant (CG 2). However, different QoS requirements for the data flows to be transmitted are not considered by the network yet in the configuration of the CGs.

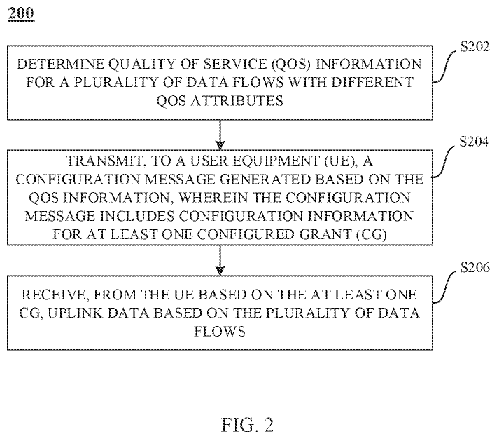

FIG. 2 illustrates a flowchart for an exemplary method for a network in accordance with some embodiments. The method 200 illustrated in FIG. 2 may be implemented by the UE 101 described in FIG. 1.

At step 202, the network may determine quality of service (QoS) information for a plurality of data flows with different QoS attributes.

The plurality of data flows may include user data generated by application server or received from external data network (e.g., the Internet). The plurality of data flows may have different QoS attributes. The QoS information may be any information indicating the QoS attributes of the data flows. In some examples, the QoS information may indicate mapping information of the QoS flows. For example, the mapping information may indicate a mapping between QoS flows and LCHs (or data radio bearers (DRBs)). For another example, the mapping information may indicate a mapping between the IP flows and the QoS flows.

In some embodiments, the plurality of data flows may be mapped to different Internet Protocol (IP) flows in the Non Access Stratum (NAS) layer. Thus, the different IP flows may have different QoS attributes. IP flow identifiers (IDs) or a priority IDs may be assigned to the different IP flows to indicates the QoS attributes.

The QoS information may include IP flow identifier (ID) per packet in the QoS flow. In some implementations, the IP flows may be mapped to a same QoS flow. When mapping the IP flows to the QoS flow. The IP flow ID or the priority ID may be indicated per packet in order to identify to which IP flow the corresponding packet belongs in the NAS layer.

The QoS information may include QoS Flow IDs (QFIs)/5G QoS Identifiers (5QIs) and/or QoS profiles of the QoS flows. In some other implementations, the IP flows may be mapped to different QoS flows. The different QoS attributes for the data flows may be indicated by the QoS Flow IDs (QFIs)/5G QoS Identifiers (5QIs) and/or QoS profiles of the QoS flows.

The QoS information may include LCH IDs. In yet other implementations, the different QoS flows may be mapped to different LCHs. Therefore, different LCH IDs may indicate different QoS attributes.

At step 204, the network may transmit, to a user equipment (UE), a configuration message generated based on the QoS information, wherein the configuration message includes configuration information for at least one configured grant (CG).

In some embodiments, the configuration message may be transmitted via a radio resource control (RRC) message or a physical layer signaling. The configuration message may include configuration information for at least one CG.

The network may send an RRC message to the UE to configure an uplink grant and the uplink grant may be stored as a CG. The configured CG may be activated or deactivated based on signaling from the network. The configuration information for the CG may include periodicity of the CG, and uplink data may be transmitted in each occasion of the CG based on the configured periodicity.

The configuration message may be generated based on the QoS information of the data flows.

In some embodiments, the configuration information may be generated based on mapping information of QoS flows in the AS layer.

In some implementations, in case that the plurality of data flows with different QoS attributes are mapped to different LCHs, the configuration information in the configuration message may indicate that different LCHs are allowed to be transmitted based on different CGs (or different occasions within a same CG), respectively. In some other implementations, in case that the plurality of data flows with different QoS attributes are mapped to different QoS flows, the configuration information in the configuration message may indicate that different QoS flows are allowed to be transmitted based on different CGs (or different occasions within a same CG), respectively. In yet some other implementations, in case that the plurality of data flows with different QoS attributes are mapped to different IP flows but the same QoS flow, the configuration information in the configuration message may indicate that the packets in the QoS flow am allowed to be transmitted based on different CGs (or different occasions within a same CG) based on per packet info (e.g., the IP flow IDs).

In some embodiments, the configuration information may be generated based on TB size of the QoS flow.

In some implementations, the CG may be configured to support a same TB size in each occasion of the CG. In some other implementations, the CG may be configured to support different TB sizes in different occasions of the CG.

At step 206, the network may receive, from the UE based on the at least one CG, uplink (UL) data based on the plurality of data flows.

In each occasion of the at least one CG configured by the configuration message, the network may receive uplink data from the UE. The uplink data is assembled based on data from the QoS flow(s) mapped to plurality of data flows.

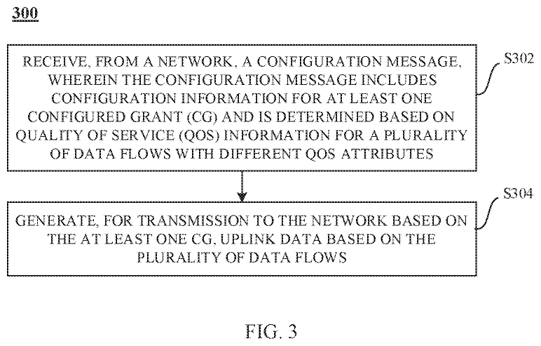

FIG. 3 illustrates a flowchart for an exemplary method for a user device in accordance with some embodiments. The method 300 illustrated in FIG. 3 may be implemented by the UE 101 described in FIG. 1.

At step S302, the UE may receive, from a network, a configuration message, wherein the configuration message includes configuration information for at least one configured grant (CG) and is determined based on quality of service (QoS) information for a plurality of data flows with different QoS attributes.

In some embodiments, the configuration message may be transmitted via a radio resource control (RRC) message or a physical layer signaling. The configuration message may include configuration information for at least one CG.

The UE may receive the configuration message and store the at least one CG. If the stored CG is activated, the UE may send LL data to the network in each occasion of the activated CG.

At step S304, the UE may generate, for transmission to the network based on the at least one CG, uplink data based on the plurality of data flows.

According to the method for configuring CG provided in the present disclosure, the CG is configured to provide scheduling for data flows with different QoS attribute. In other word, the present disclosure provides a manner for configuring transmission of data with different QoS requirements with different scheduling.

In some embodiments, step S202 may include the network determining the QoS information for the plurality of data flows based on suggestion information reported by the UE. The network may receive the suggestion information regarding the QoS information from the UE and determine the QoS information based on the suggestion UE. In some examples, the suggestion information may be received directly by the base station. In some other examples, the suggestion information may be received by a core network (CN) and forwarded to the base station by the CN.

In some other embodiments, step S202 may include the network determining the QoS information by itself. The CN may determine the QoS information via an application server and inform the base station about the determined QoS information.

From the UE side, method 300 may further include the UE generating suggestion information, for transmission to the network, regarding the QoS information for the plurality of data flows. The suggestion information may be transmitted to the core network (CN) or a base station.

The suggestion information may indicate preference on mappings between the QoS flows (QFIs) and the LCHs. In some examples, the suggestion information may include suggested traffic pattern provided for each mapping between the QFIs and the LCHs. In some other examples, the suggestion information may include suggested traffic pattern for a QFI set associated with a same LCH. The suggestion information may be a full set of preferred traffic pattern for each mapping, or a preferred change based on a current configuration.

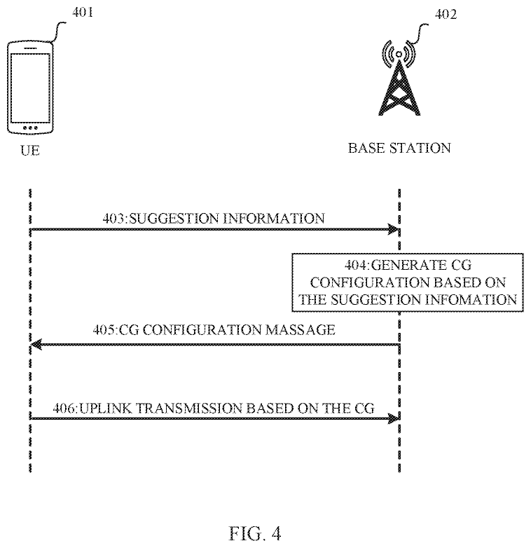

FIG. 4 illustrates a communication exchange in connection with determination of the suggestion information in accordance with some embodiments of the present disclosure.

As shown in FIG. 4, the UE 401 may send the suggestion information to the base station 402 at operation 403. The suggestion information may include suggested traffic pattern for the QoS flows or the LCHs.

At operation 404, the base station 402 may generate at least one CG configuration based on the suggestion information. Based on the suggested traffic pattern in the suggestion information, the base station 402 may determine at least one transmission pattern for the transmission based on the CG(s).

At operation 405, the base station 402 may transmit at least one CG configuration message to the UE.

At operation 406, the UE 401 may perform uplink transmission based on the CG(s) configured by the configuration message(s) received at operation 405.

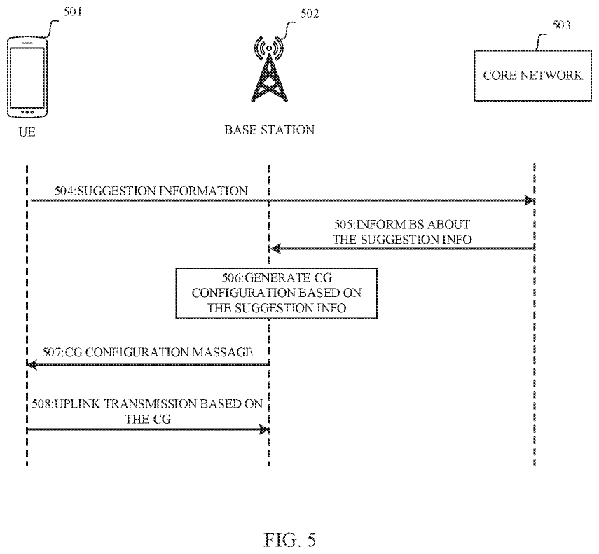

FIG. 5 illustrates another communication exchange in connection with determination of the suggestion information in accordance with some embodiments of the present disclosure.

As shown in FIG. 5, the UE 501 may send suggestion information to the CN 503 at operation 504. The suggestion information may include suggested traffic pattern for the QoS flows or the LCHs.

At operation 505, the CN 503 may forward the suggestion information to the base station 502 and inform the base station 502 about the suggestion information.

At operation 506, the base station 502 may generate at least one CG configuration based on the suggestion information. Based on the suggested traffic pattern in the suggestion information, the base station 502 may determine at least one transmission pattern for the transmission based on the CG(s).

At operation 507, the base station 502 may transmit at least one CG configuration message to the UE.

At operation 508, the UE 501 may perform uplink transmission based on the CG(s) configured by the configuration message(s) received at operation 507.

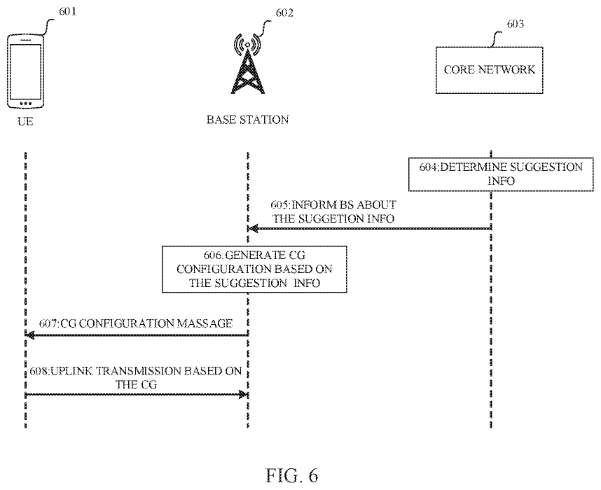

FIG. 6 illustrates yet another communication exchange in connection with determination of the suggestion information in accordance with some embodiments of the present disclosure.

As shown in FIG. 6, the CN 603 may determine the suggestion information, e.g., via an application server at operation 604.

At operation 605, the CN 603 may inform the base station 602 about the suggestion information. The suggestion information may include suggested traffic pattern for the QoS flows or the LCHs.

At operation 606, the base station 602 may generate at least one CG configuration based on the suggestion information. Based on the suggested traffic pattern in the suggestion information, the base station 602 may determine at least one transmission pattern for the transmission based on the CG(s).

At operation 607, the base station 602 may transmit at least one CG configuration message to the UE.

At operation 6418, the UE 601 may perform uplink transmission based on the CG(s) configured by the configuration message(s) received at operation 607.

In some embodiments, the plurality of data flows may include a first data flow and a second data flow. The first data flow and the second data flow are configured with different QoS attributes. The at least one CG configured by the configuration message may include a first CG and a second CG. The second CG is different from the first CG.

In some implementations, the first data flow is mapped to a first LCH (LCH 1), and the second data flow is mapped to a second LCH (LCH 2) which is different from the first LCH. For example, the network may determine QoS information indicating the mapping of the first data flow and the LCH 1, and the mapping of the second data flow and the LCH 1. Thus, the network may configure the different QoS flows corresponding to the first data flow and the second data flow to be mapped to different LCHs. The base station (e.g., gNB) of the network may provide scheduling to meet LCH/DRB level QoS requirement.

The network may further configure the different LCHs for the first data flow and the second data flow to be mapped to different CGs. For example, the configuration information transmitted from the network to the UE may indicate that the first LCH is configured to be transmitted based on the first CG, and the second LCH is configured to be transmitted based on the second CG.

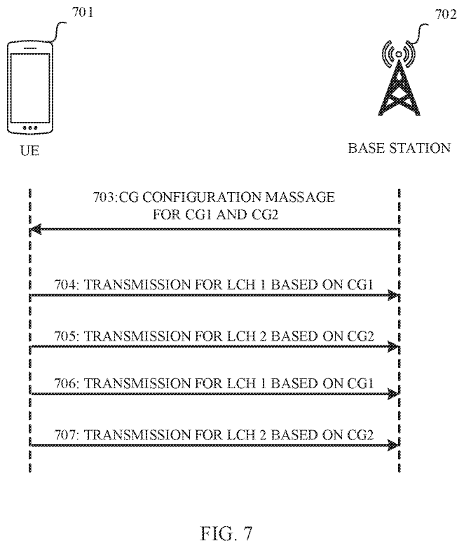

FIG. 7 illustrates a communication exchange in connection with uplink transmission based on the CGs in accordance with some embodiments of the present disclosure.

As shown in FIG. 7, the base station 702 may send, to the UE 701, the CG configuration message for the first CG (CG 1) and the second CG (CG 2) at operation 703.

When CG 1 is activated, the UE 701 may perform uplink transmission for LCH 1 based on CG 1. For example, in each occasion of CG 1, the Packet Data Convergence Protocol (PDCP) may assemble protocol data units (PDUs) based on the LCH to CG mapping, and the user data in LCH 1 may be transmitted in the uplink transmission. At operations 704 and 706, the UE may transmit data of LCH 1 in a first occasion of CG 1 and a second occasion of CG 1, respectively.

Similarly, the UE 701 may perform uplink transmission for LCH 2 based on CG 2. For example, in each occasion of CG 2, the user data in LCH 2 may be transmitted in the uplink transmission. At operations 705 and 707, the UE may transmit data of LCH 2 in a first occasion of CG 2 and a second occasion of CG 2, respectively.

According to the embodiments of the present disclosure, the network may be aware of QoS requirement for data flows and configure the data flow with different QoS attributes to be mapped to different LCHs. Thus, by configuring different LCHs to be mapped into different CGs, the data with different QoS attributes may be scheduled in different patterns to satisfy different QoS requirements.

Current mechanism support scheduling to meet a LCH/DRB level QoS requirement, which maps different LCHs to different CGs. However, if the AS layer only provides LCH based scheduling, different QoS flow mapped into a same LCH will be scheduled in a same pattern. In order to provide a QoS flow level QoS requirement, a mapping of QoS flow (QFI/5QI) and CG is introduced.

In some other implementations, the first data flow may be mapped to a first QoS flow and the second data flow may be mapped to a second QoS flow. The second QoS flow may be different from the first QoS flow. For example, the QoS parameters and QoS characteristics of the second QoS flow may be different from that of the first QoS flow. In some examples, the first QoS flow and the second QoS flow may be mapped to a same LCH (e.g., the first LCH) or mapped to different LCHs respectively (e.g., the first QoS flow mapped to the first LCH and the second QoS flow mapped to the second LCH).

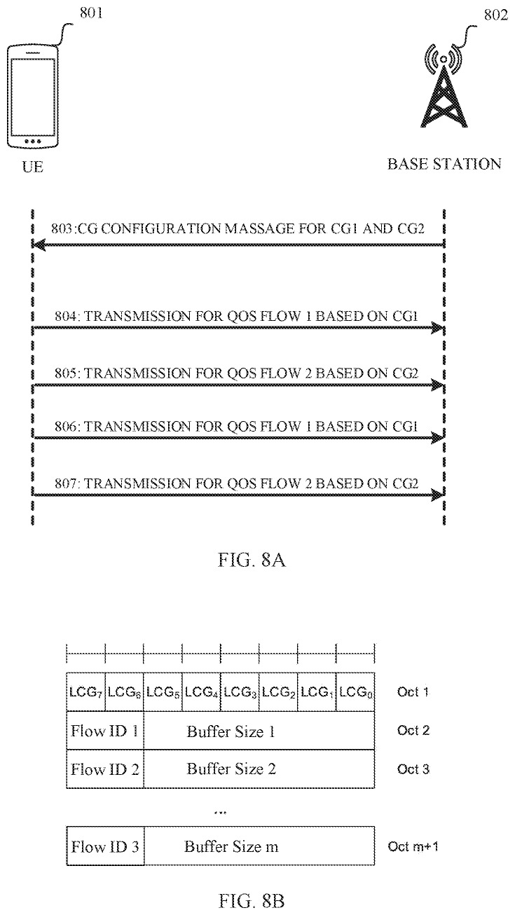

FIG. 8A illustrates another communication exchange in connection with uplink transmission based on the CGs in accordance with some embodiments of the present disclosure.

As shown in FIG. 8A, the base station 802 may send, to the UE 80, the CG configuration message for the first CG (CG 1) and the second CO (CG 2) at operation 803. The configuration information of the CG configuration message may indicate that the first QoS flow (QoS flow 1) is configured to be transmitted based on CG 1, and the second QoS flow (QoS flow 2) may be configured to be transmitted based on CG 2.

When CG 1 is activated, the UE 801 may perform uplink transmission for QoS flow 1 based on CG 1. For example, in each occasion of CG 1, the Packet Data Convergence Protocol (PDCP) may assemble protocol data units (PDUs) based on the QoS flow to CG mapping, and the user data in QoS flow 1 and QoS flow 2 may be transmitted in the uplink transmission. At operations 804 and 806, the UE may transmit data of QoS flow 1 in a first occasion of CG 1 and a second occasion of CG 1, respectively.

Similarly, the UE 801 may perform uplink transmission for QoS flow 2 based on CG 2. For example, in each occasion of CG 2, the user data in QoS flow 2 may be transmitted in the uplink transmission. At operations 805 and 8417, the UE may transmit data of QoS flow 2 in a first occasion of CG 2 and a second occasion of CG 2, respectively.

FIG. 8B illustrates an exemplar Medium Access Control (MAC)-Control Element (CE) in accordance with some embodiments of the present disclosure.

As shown in FIG. 8B, when the UE reports buffer status report (BSR) for the uplink transmission to the network, the BSR via MAC-CE may include buffer sizes for different QoS flows. For example, the BSR may include a first buffer size (Buffer Size 1) for the first QoS flow (Flow ID 1), and a second buffer size (Buffer Size 2) for the second QoS flow (Flow ID 2), respectively.

From the network side, the network may receive BSR from the UE, wherein the BSR includes a first buffer size for the first QoS flow and a second buffer size for the second QoS flow, respectively.

From the UE side, the UE may generate buffer status report (BSR) for transmission to the network, wherein the BSR includes a first buffer size for the first QoS flow and a second buffer size for the second QoS flow, respectively.

By providing different buffer sizes for different QoS flows in the BSR, the UE may report more detailed information regarding different QoS flows, thus scheduling based on the different QoS flows may be provided.

In the example shown in FIG. 8A, each CG is configured for a single QoS flow. In other examples, the CG may be configured for two or more QoS flows. The plurality of data flows may further include a third data flow which is different from the first data flow and the second data flow. The QoS information of the third data flow may indicate that the third data flow is mapped to a third QoS flow which is different from the first QoS flow. The third QoS flow may be also configured to be transmitted based on the first CG together with the first QoS flow.

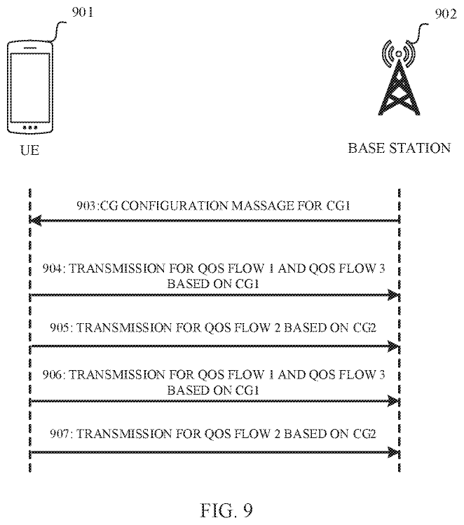

FIG. 9 illustrates yet another communication exchange in connection with uplink transmission based on the CGs in accordance with some embodiments of the present disclosure.

As shown in FIG. 9, the base station 902 may send, to the UE 901, the CG configuration message for the first CG (CG 1) and the second CG (CG 2) at operation 903. The configuration information of the CG configuration message may indicate that the first QoS flow (QoS flow 1) and the third QoS flow (QoS flow 3) are configured to be transmitted based on CG 1, and the second QoS flow (QoS flow 2) may be configured to be transmitted based on CG 2. In some examples, QoS flow 1, QoS flow 2, and QoS flow 3 may be mapped to a same LCH (e.g., the first LCH) or mapped to different LCHs respectively.

When CG 1 is activated, the UE 901 may perform uplink transmission for QoS flow 1 and QoS flow 2 based on CG 1. At operations 904 and 906, the UE may transmit data of QoS flow 1 and QoS flow 3 in a first occasion of CG 1 and a second occasion of CG 1, respectively.

Similarly, the UE 901 may perform uplink transmission for QoS flow 2 based on CG 2. At operations 905 and 9117, the UE may transmit data of QoS flow 2 in a first occasion of CG 2 and a second occasion of CG 2, respectively.

In the example shown in FIG. 9, QoS flow 3 may be transmitted at the same time with QoS flow 1.

Although two QoS flows (QoS flow 1 and QoS flow 3) are configured to be transmitted based on CG 1, according to the principle of the present disclosure, more QoS flows may be configured to be transmitted based on a single CG. Furthermore, a single CG may also be configured for more than one CG. For example, QoS flow 1 may be configured for both CG 1 and CG 2. As an example, CG 1 may be configured for transmission of QoS flow 1 and QoS flow 3, and CG 2 may be configured for transmission of QoS flow 1. Those skilled in the art may determine the number of QoS flows to be transmitted based on a same CG according actual QoS requirements.

According to the embodiments of the present disclosure, the network (e.g., the gNB) may provide mapping between the QFIs of the QoS flows and the CG in the configuration message. The mapping of the QFIs and the CGs may be a one-to-one mapping or a many-to-one mapping. For example, a CG may be configured to allow transmission of a plurality of QoS flows with different QFIs, or QoS flows with the same QFI may be configured to be transmitted based on a plurality of different CGs Thus, by configuring different QoS flows to be mapped into different CGs, different QoS flows may be scheduled in different patterns to satisfy different QoS requirements, even when the QoS flows are mapped to the same LCH.

In yet other implementations, the first data flow may be mapped to a first IP flow and the second data flow may be mapped to a second IP flow which is different from the first IP flow. The configuration information may indicate that the first IP flow is configured to be transmitted based on the first CG, and the second IP flow is configured to be transmitted based on the second CG The first IP flow and the second IP flow may be mapped to the same QoS flow or different QoS flows in the AS layer.

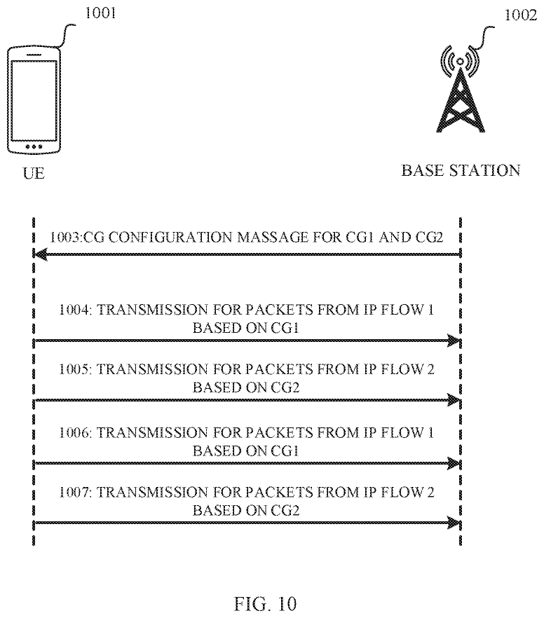

If the first IP flow and the IP flow are mapped to different QoS flows in the AS layer, the network may provide scheduling for the different QoS flows as described in connection with FIG. 8A and FIG. 9. However, if the first IP flow and the second IP flow are mapped to the same QoS flow in the AS layer, the AS layer may provide LCH based or QoS based scheduling regardless which IP flow is mapped inside, since the mapping between IP flows and the QoS flows are invisible to the AS level. Thus, the present disclosure provides a packet-based scheduling for different IP flows mapped to the same QoS flow. It should also be acknowledged that the packet-based scheduling described in connection with FIG. 10 can also be applied even when the different IP flows are mapped to different QoS flows.

FIG. 10 illustrates yet another communication exchange in connection with uplink transmission based on the CGs in accordance with some embodiments of the present disclose.

As shown in FIG. 10, the base station 1002 may send, to the UE 1001, the CG configuration message for the first CO (CG 1) and the second CG (CG 2) at operation 1001. The configuration information of the CG configuration message may indicate that packets from the first IP flow (IP flow 1) may be configured to be transmitted based on CG 1, and the packets from the second IP flow (IP flow 2) may be configured to be transmitted based on CG 2. The packets may be identified by per packet information such as an IP flow ID or a priority ID indicated for the packet in the QoS flow. Different IP flow ID of the packets may indicate different QoS requirement for the packets. The AS layer/Medium Access Control (MAC) may perform the packet and CG mapping based on the per packet information.

When CG 1 is activated, the UE 1001 may perform uplink transmission for packets from IP flow 1 based on CG 1. At operations 1004 and 1006, the UE may transmit packets from IP flow 1 in a first occasion of CG 1 and a second occasion of CG 1, respectively.

Similarly, the UE 1001 may perform uplink transmission for packets from IP flow 2 based on CG 2. At operations 1005 and 1007, the UE may transmit data of packets from IP flow 2 in a first occasion of CG 2 and a second occasion of CG 2, respectively.

According to the embodiments of the present disclosure, the network (e.g., the gNB) may provide mapping between the per packet information in the same QoS flow and the CG in the configuration message. The mapping of the per packet information and the CGs may be a one-to-one mapping or a many-to-one mapping. For example, a CG may be configured to allow transmission of a plurality of packets with different IP flow ID, or packets with the same IP flow ID may be configured to be transmitted based on a plurality of different CGs. Thus, by configuring different packets in the same QoS flow to be mapped into different CGs, different packet may be scheduled in different patterns to satisfy different QoS requirements, even when the packets are mapped to the same QoS flow.

In current configuration for the CG, each occasion of the CG may support a same TB size. In order to provide a more flexible transmission pattern for the CGs, the preset disclosure introduces a CG configuration in which each occasion of the CG may support different TB sizes. For example, a first occasion of the first CG may be configured to support a first TB size, and a second occasion of the first CG may be configured to support a second TB size which is different from the first TB size.

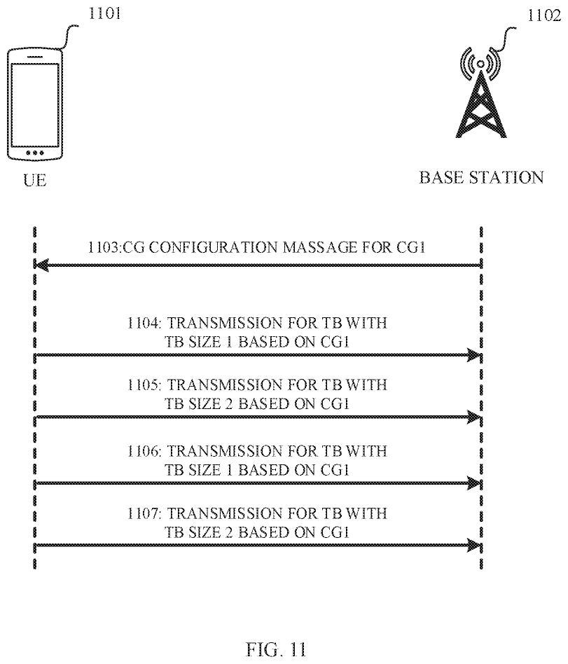

FIG. 11 illustrates yet another communication exchange in connection with uplink transmission based on the CGs in accordance with some embodiments of the present disclosure.

As shown in FIG. 11, the base station 1102 may send, to the UE 1101, the CG configuration message for the first CG (CG 1) at operation 1103. The configuration information of the CG configuration message may indicate that a first occasion of CG1 is configured to support a first TB size (TB size 1), and a second occasion of CG 1 is configured to support a second TB size (TB size 2) which is different from the first TB size. For example, odd occasions of CG 1 may be configured to support TB size 1, and even occasions of CG 1 may be configured to support TB size 2.

When CG 1 is activated, the UE 1101 may perform uplink transmission based on CG 1. At operations 1104 and 1106, the UE may transmit data of TB size 1 in a first occasion of CG 1 and a third occasion of CG 1, respectively. Similarly, at operations 1105 and 1107, the UE may transmit data of TB size 2 in a second occasion of CG 1 and a fourth occasion of CG 1, respectively.

Although the CG configuration only supports two TB sizes in CG 1 in the example described in FIG. 11, those skilled in the art can configure a single CG to support more TB sizes, and the mapping between the TB sizes and occasions of the CG.

In some examples, the TB sizes supported by the CG may be explicitly configured in the configuration information. The configuration information may define the different TB sizes and the mapping of the TB sizes and occasions of the CG, so that the UE may perform uplink transmission according to the configuration information. For example, the configuration information may indicate TB size 1 for the first occasion of the CG and TB size 2 for the second occasion of the CG in an explicit manner.

In some other examples, the TB sizes supported by the CG may be configured without explicit mapping.

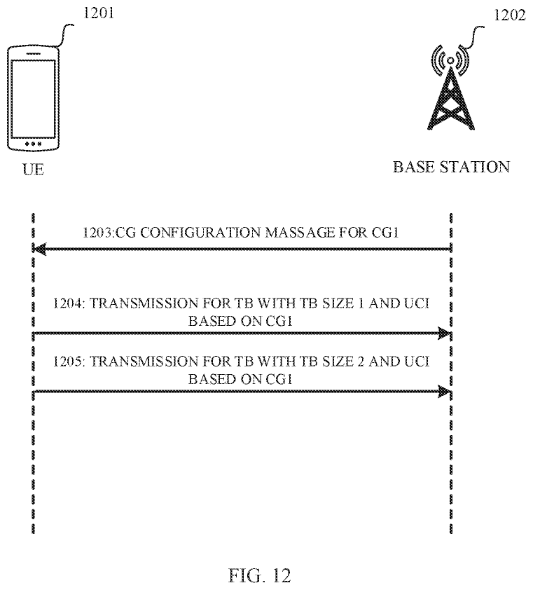

FIG. 12 illustrates yet another communication exchange in connection with uplink transmission based on the CGs in accordance with some embodiments of the present disclosure.

As shown in FIG. 12, the base station 1202 may send, to the UE 1101, the CG configuration message for the first CG (CG 1) at operation 1203. The configuration information of the CG configuration message may indicate that each occasion of CO 1 supports a set of TB sizes. For example, the configuration information may indicate that a first occasion of CG1 is configured to support a first TB size range (TB size set 1), and a second occasion of CG 1 is configured to support a second TB size range (TB size set 2) which is different from TB size set 1. For another example, the configuration information may indicate that the occasions of CO 1 are configured to support a same set of TB sizes (e.g., TB size set 1). The TB size sets can be indicated with actual TB sizes or TB size indices.

When CG 1 is activated, the UE 1201 may perform uplink transmission based on CG 1. Generating uplink data based on the plurality of data flows may include generating a transport block including the uplink data to be transmitted based on the first CG and uplink control information (UCI) indicating an actual size of the TB, wherein the actual size of the TB is selected from the set of TB size indicated in the configuration information.

At operations 1204, the UE may determine TB size 1, and generate a TB of TB size 1 in a first occasion of CG 1 together with an uplink control information (UCI) of the Physical Uplink Shared Channel (PUSCH) transmission. The TB may include the uplink data to be transmitted based on CG. The UCI may indicate an actual size of the TB being transmitted at operation 1204. The actual size of the TB is selected from the TB size set indicated in the configuration information. The network may receive the UCI and TB transmitted in operation 1204, and determine the actual TB size of the TB based on the UC, and decode the received TB based on the determined actual TB size. Similarly, at operations 1205 and 1107, the IE may transmit data of TB size 2, which is selected from the TB size set configured in the configuration message in a second occasion of CG 1.

According to the embodiments of the present disclosure, a configuration of CG with variable TBs is introduced. For a first service data with a first size to be transmitted every 20 ns, and a second service data with a second size to be transmitted every 40 ms, the CG may be configured with a periodicity of 20 ms, and the odd occasions are configured with a first TB size of a sum of the first size and the second size, and the even occasions are configured with a second TB size of the first size. Thus, with variable TB sizes configured for the CG, different data flows may be transmitted based on the same CG and the mapping of the QoS flows to the CGs may be omitted.

It should also be acknowledged that the mapping of LCHs to the CGs, the mapping of QoS flows to the CGs, the mapping of per-packet information to the CGs and the variable TB size configuration within one CG may be applied simultaneously. Those skilled in the art could select one or more of the configuration manners according to actual QoS requirements.

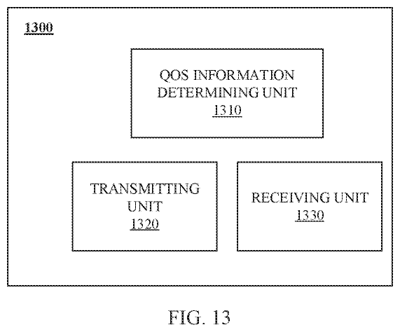

FIG. 13 illustrates an exemplary block diagram of an apparatus for a network in accordance with some embodiments. The apparatus 1300 illustrated in FIG. 13 may be used to implement the method 200 as illustrated in combination with FIG. 2.

As illustrated in FIG. 13, the apparatus 1300 includes a QoS information determining unit 1310, a transmitting unit 1320 and a receiving unit 1330.

The QoS information determining unit 1310 may be configured to determine quality of service (QoS) information for a plurality of data flows with different QoS attributes.

The transmitting unit 1320 may be configured to transmit, to a user equipment (UE), a configuration message generated based on the QoS information, wherein the configuration message includes configuration information for at least one configured grant (CG).

The receiving unit 1330 may be configured to receive, from the UE based on the at least one CG, uplink data based on the plurality of data flows.

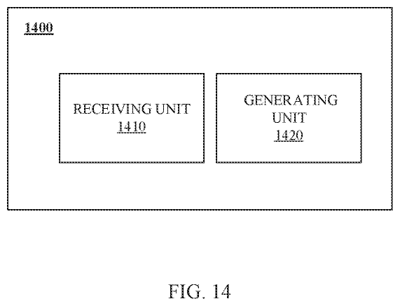

FIG. 14 illustrates an exemplary block diagram of an apparatus for UE in accordance with some embodiments. The apparatus 1400 illustrated in FIG. 14 may be used to implement the method 300 as illustrated in combination with FIG. 3.

As illustrated in FIG. 14, the apparatus 1400 includes a receiving unit 1410 and a generating unit 1420.

The receiving unit 1410 may be configured to receive, from a network, a configuration message, wherein the configuration message includes configuration information for at least one configured grant (CG) and is determined based on quality of service (QoS) information for a plurality of data flows with different QoS attributes.

The generating unit 1420 may be configured to generate, for transmission to the network based on the at least one CG, uplink data based on the plurality of data flows.

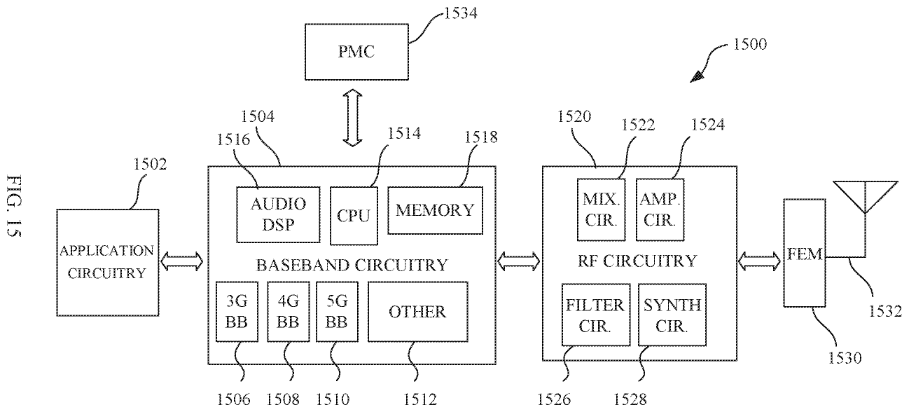

FIG. 15 illustrates example components of a device 1500 in accordance with some embodiments. In some embodiments, the device 1500 may include application circuitry 1502, baseband circuitry 1504, Radio Frequency (RF) circuitry (shown as RF circuitry 1520), font-end module (FEM) circuitry (shown as FEM circuitry 1530), one or more antennas 1532, and power management circuitry (PMC) (shown as PMC 1534) coupled together at least as shown. The components of the illustrated device 1500 may be included in a UE or a RAN node In some embodiments, the device 1500 may include fewer elements (e.g., a RAN node may not utilize application circuitry 1502, and instead include a processor/controller to process IP data received from an EPC). In some embodiments, the device 1500 may include additional elements such as, for example, memory/storage, display, camera, sensor, or input/output (I/O) interface In other embodiments, the components described below may be included in more than one device (e.g., said circuitries may be separately included in more than one device for Cloud-RAN (C-RAN) implementations).

The application circuitry 1502 may include one or more application processors. For example, the application circuitry 1502 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 1500. In some embodiments, processors of application circuitry 1502 may process IP data packets received from an EPC.

The baseband circuitry 1504 may include circuitry such as, but not limited to, one or more single-core or multi-core processors. The baseband circuitry 1504 may include one or more baseband processors or control logic to process baseband signals received from a receive signal path of the RF circuitry 1520 and to generate baseband signals for a transmit signal path of the RF circuitry 1520. The baseband circuitry 1504 may interface with the application circuitry 1502 for generation and processing of the baseband signals and for controlling operations of the RF circuitry 1520. For example, in some embodiments, the baseband circuitry 1504 may include a third generation (3G) baseband processor (3G baseband processor 1506), a fourth generation (4G) baseband processor (4G baseband processor 1508), a fifth generation (5G) baseband processor (5G baseband processor 1510), or other baseband processor(s) 1512 for other existing generations, generations in development or to be developed in the future (e.g., second generation (2G), sixth generation (6G), etc.). The baseband circuitry 1504 (e.g., one or more of baseband processors) may handle various radio control functions that enable communication with one or more radio networks via the RF circuitry 1520. In other embodiments, some or all of the functionality of the illustrated baseband processors may be included in modules stored in the memory 1518 and executed via a Central Processing ETnit (CPET 1514). The radio control functions may include, but are not limited to, signal modulation/demodulation, encoding/decoding, radio frequency shifting, etc. In some embodiments, modulation/demodulation circuitry of the baseband circuitry 1504 may include Fast-Fourier Transform (FFT), precoding, or constellation mapping/demapping functionality. In some embodiments, encoding/decoding circuitry of the baseband circuitry 1504 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 1504 may include a digital signal processor (DSP), such as one or more audio DSP(s) 1516. The one or more audio DSP(s) 1516 may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 1504 and the application circuitry 1502 may be implemented together such as, for example, on a system on a chip (SOC).

In some embodiments, the baseband circuitry 1504 may provide for communication compatible with one or more radio technologies. For example, in some embodiments, the baseband circuitry 1504 may support communication with an evolved universal terrestrial radio access network (EUTRAN) or other wireless metropolitan area networks (WMAN), a wireless local area network (WLAN), or a wireless personal area network (WPAN). Embodiments in which the baseband circuitry 1504 is configured to support radio communications of more than one wireless protocol may be referred to as multi-mode baseband circuitry.

The RF circuitry 1520 may enable communication with wireless networks using modulated electromagnetic radiation through a non-solid medium. In various embodiments, the RF circuitry 1520 may include switches, filters, amplifiers, etc., to facilitate the communication with the wireless network. The RF circuitry 1520 may include a receive signal path which may include circuitry to down-convert RF signals received from the FEM circuitry 1530 and provide baseband signals to the baseband circuitry 1504. The RF circuitry 1520 may also include a transmit signal path which may include circuitry to up-convert baseband signals provided b, the baseband circuitry 1504 and provide RF output signals to the FEM circuitry 1530 for transmission.

In some embodiments, the receive signal path of the RF circuitry 1520 may include mixer circuitry 1522, amplifier circuitry 1524 and filter circuitry 1526. In some embodiments, the transmit signal path of the RF circuitry 1520 may include filter circuitry 1526 and mixer circuitry 1522. The RF circuitry 1520 may also include synthesizer circuitry 1528 for synthesizing a frequency for use by the mixer circuitry 1522 of the receive signal path and the transmit signal path. In some embodiments, the mixer circuitry 1522 of the receive signal path may be Configured to down-convert RF signals received from the FEM circuitry 1530 based on the synthesized frequency provided by synthesizer circuitry 1528. The amplifier circuitry 1524 may be configured to amplify the down-converted signals and the filter circuitry 1526 may be a low-pass filter (LPF) or band-pass filter (BPF) configured to remove unwanted signals from the down-converted signals to generate output baseband signals. Output baseband signals may be provided to the baseband circuitry 1504 for further processing. In some embodiments, the output baseband signals may be zero-frequency baseband signals, although this is not a requirement. In some embodiments, the mixer circuitry 1522 of the receive signal path may comprise passive mixers, although the scope of the embodiments is not limited in this respect.

In some embodiments, the mixer circuitry 1522 of the transmit signal path may be configured to up-convert input baseband signals based on the synthesized frequency provided by the synthesizer circuitry 1528 to generate RF output signals for the FEM circuitry 1530. The baseband signals may be provided by the baseband circuitry 1504 and may be filtered by the filter circuitry 1526.

In some embodiments, the mixer circuitry 1522 of the receive signal path and the mixer circuitry 1522 of the transmit signal path may include two or more mixers and may be arranged for quadrature downconversion and upconversion, respectively. In some embodiments, the mixer circuitry 1522 of the receive signal path and the mixer circuitry 1522 of the transmit signal path may include two or more mixers and may be arranged for image rejection (e.g., Hartley image rejection). In some embodiments, the mixer circuitry 1522 of the receive signal path and the mixer circuitry 1522 may be arranged for direct downconversion and direct upconversion, respectively. In some embodiments, the mixer circuitry 1522 of the receive signal path and the mixer circuitry 1522 of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 1520 may include analog-to-digital converter (ADC) and digital-to-analog converter (DAC) circuitry and the baseband circuitry 1504 may include a digital baseband interface to communicate with the RF circuitry 1520.

In some dual-mode embodiments, a separate radio IC circuitry may be provided for processing signals for each spectrum, although the scope of the embodiments is not limited in this respect.

In some embodiments, the synthesizer circuitry 1528 may be a fractional −N synthesizer or a fractional N/N+1 synthesizer, although the scope of the embodiments is not limited in this respect as other types of frequency synthesizers may be suitable. For example, synthesizer circuitry 1528 may be a delta-sigma synthesizer, a frequency multiplier, or a synthesizer comprising a phase-locked loop with a frequency divider.

The synthesizer circuitry 1528 may be configured to synthesize an output frequency for use by the mixer circuitry 1522 of the RF circuitry 1520 based on a frequency input and a divider control input. In some embodiments, the synthesizer circuitry 1528 may be a fractional N/N+1 synthesizer.

In some embodiments, frequency input may be provided by a voltage controlled oscillator (VCO), although that is not a requirement. Divider control input may be provided by either the baseband circuitry 1504 or the application circuitry 1502 (such as an applications processor) depending on the desired output frequency In some embodiments, a divider control input (e.g., N) may be determined from a look-up table based on a channel indicated by the application circuitry 1502.

Synthesizer circuitry 1528 of the RF circuitry 1520 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, the synthesizer circuitry 1528 may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 1520 may include an IQ/polar converter.

The FEM circuitry 1530 may include a receive signal path which may include circuitry configured to operate on RF signals received from one or more antennas 1532, amplify the received signals and provide the amplified versions of the received signals to the RF circuitry 1520 for further processing. The FEM circuitry 1530 may also include a transmit signal path which may include circuitry configured to amplify signals for transmission provided by the RF circuitry 1520 for transmission by one or more of the one or more antennas 1532. In various embodiments, the amplification through the transmit or receive signal paths may be done solely in the RF circuitry 1520, solely in the FEM circuitry 1530, or in both the RF circuitry 1520 and the FEM circuitry 1530.

In some embodiments, the FEM circuitry 1530 may include a TX/RX switch to switch between transmit mode and receive mode operation. The FEM circuitry 1530 may include a receive signal path and a transmit signal path. The receive signal path of the FEM circuitry 1530 may include an LNA to amplify received RF signals and provide the amplified received RF signals as an output (e.g., to the RF circuitry 1520). The transmit signal path of the FEM circuitry 1530 may include a power amplifier (PA) to amplify input RF signals (e.g., provided by the RF circuitry 1520), and one or more filters to generate RF signals for subsequent transmission (e.g., by one or more of the one or more antennas 1532).

In some embodiments, the PMC 1534 may manage power provided to the baseband circuitry 1504. In particular, the PMC 1534 may control power-source selection, voltage scaling, battery charging, or DC-to-DC conversion. The PMC 1534 may often be included when the device 1500 is capable of being powered by a battery, for example, when the device 1500 is included in a EGE. The PMC 1534 may increase the power conversion efficiency while providing desirable implementation size and heat dissipation characteristics.

FIG. 15 shows the PMC 1534 coupled only with the baseband circuitry 1504. However, in other embodiments, the PMC 1534 may be additionally or alternatively coupled with, and perform similar power management operations for, other components such as, but not limited to, the application circuitry 1502, the RF circuitry 1520, or the FEM circuitry 1530.

In some embodiments, the PMC 1534 may control, or otherwise be part of, various power saving mechanisms of the device 1500. For example, if the device 1500 is in an RRC Connected state, where it is still connected to the RAN node as it expects to receive traffic shortly, then it may enter a state known as Discontinuous Reception Mode (DRX) after a period of inactivity. During this state, the device 1500 may power down for brief intervals of time and thus save power.

If there is no data traffic activity for an extended period of time, then the device 1500 may transition off to an RRC Idle state, where it disconnects from the network and does not perform operations such as channel quality feedback, handover, etc. The device 1500 goes into a very low power state and it performs paging where again it periodically wakes up to listen to the network and then powers down again. The device 1500 may not receive data in this state, and in order to receive data, it transitions back to an RRC Connected state.

An additional power saving mode may allow a device to be unavailable to the network for periods longer than a paging interval (ranging from seconds to a few hours). During this time, the dev ice is totally unreachable to the network and may power down completely. Any data sent during this time incurs a large delay and it is assumed the delay is acceptable.

Processors of the application circuitry 1502 and processors of the baseband circuitry 1504 may be used to execute elements of one or mom instances of a protocol stack. For example, processors of the baseband circuitry 1504, alone or in combination, may be used to execute Layer 3, Layer 2, or Layer 1 functionality, while processors of the application circuitry 1502 may utilize data (e.g., packet data) received from these layers and further execute Layer 4 functionality (e.g., transmission communication protocol (TCP) and user datagram protocol (UDP) layers). As referred to herein. Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

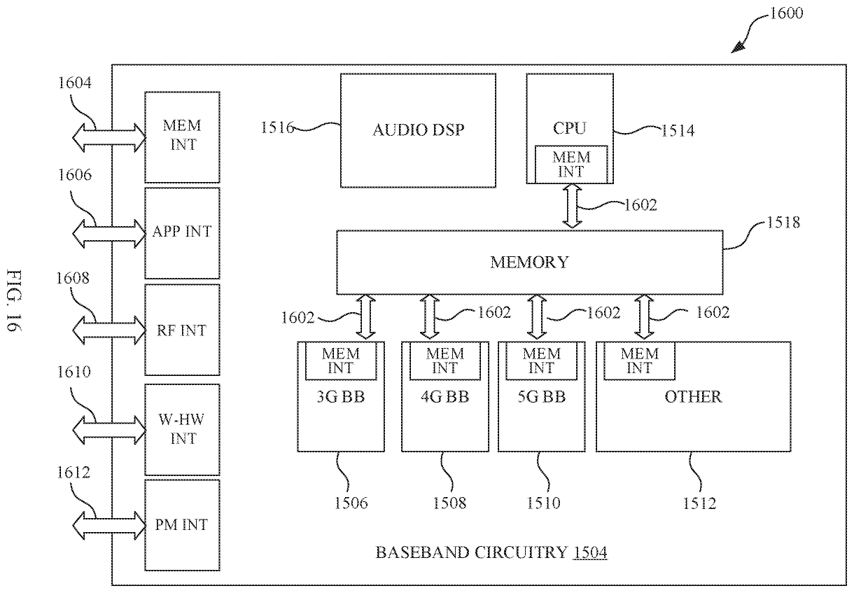

FIG. 16 illustrates example interfaces 1600 of baseband circuitry in accordance with some embodiments. As discussed above, the baseband circuitry 1504 of FIG. 15 may comprise 3G baseband processor 15416, 4G baseband processor 1508, 5G baseband processor 1510, other baseband processor(s) 1512, CPU 1514, and a memory 1518 utilized by said processors. As illustrated, each of the processors may include a respective memory interface 1602 to send/receive data to/from the memory 1518.

The baseband circuitry 1504 may further include one or more interfaces to communicatively couple to other circuitries/devices, such as a memory interface 1604 (e.g., an interface to send/receive data to/from memory external to the baseband circuitry 1504), an application circuitry interface 1606 (e.g., an interface to send/receive data to/from the application circuitry 1502 of FIG. 15), an RF circuitry interface 1608 (e.g., an interface to send/receive data to/from RF circuitry 1320 of FIG. 15), a wireless hardware connectivity interface 1610 (e.g., an interface to send/receive data to/from Near Field Communication (NFC) components, Bluetooth® components (e.g., Bluetooth® Low Energy), Wi-Fi® components, and other communication components), and a power management interface 1612 (e.g., an interface to send/receive power or control signals to/from the PMC 1534.

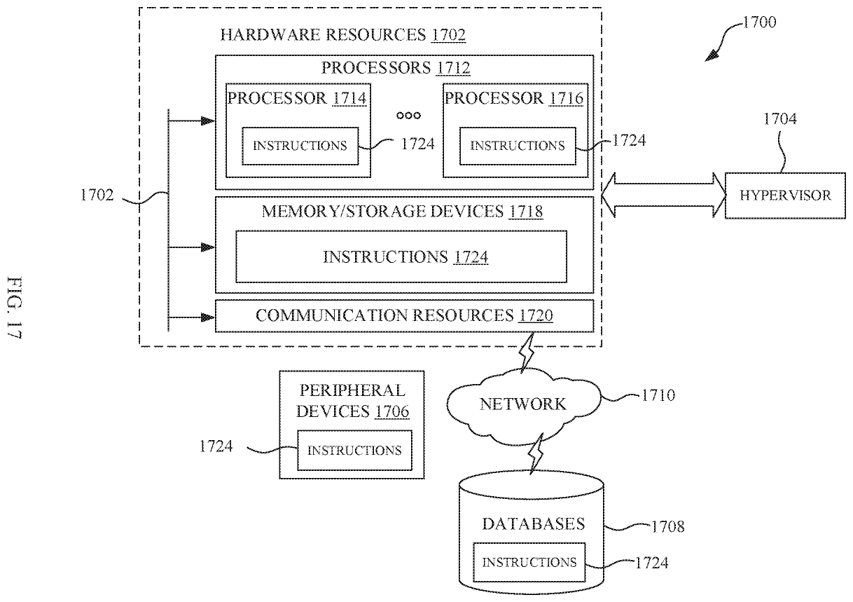

FIG. 17 is a block diagram illustrating components 1700, according to some example embodiments, able to read instructions from a machine-readable or computer-readable medium (e.g., a non-transitory machine-readable storage medium) and perform any one or more of the methodologies discussed herein. Specifically, FIG. 17 shows a diagrammatic representation of hardware resources 1702 including one or more processors 1712 (or processor cores), one or more memory/storage devices 1718, and one or more communication resources 1720, each of which may be communicatively coupled via a bus 1722. For embodiments where node virtualization (e.g., NFV) is utilized, a hypervisor 1704 may be executed to provide an execution environment for one or mom network slices/sub-slices to utilize the hardwair resources 1702.

The processors 1712 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1714 and a processor 1716.

The memory/storage devices 1718 may include main memory, disk storage, or any suitable combination thereof. The memory/storage devices 1718 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 1720 may include interconnection or network interface components or other suitable dev ices to communicate with one or more peripheral devices 1706 or one or more databases 1708 via a network 1712. For example, the communication resources 1720 may include wired communication components (e.g., for coupling via a Universal Serial Bus (USB), cellular communication components, NFC components, Bluetooth® components (e.g., Bluetooth Low Energy). Wi-Fi® components, and other communication components.

Instructions 1724 may comprise software, a program, an application, an applet, an app, or other executable code for causing at least any of the processors 1712 to perform any one or more of the methodologies discussed herein. The instructions 1724 may reside, completely or partially, within at least one of the processors 1712 (e.g., within the processor's cache memory), the memory/storage devices 1718, or any suitable combination thereof. Furthermore, any portion of the instructions 1724 may be transferred to the hardware resources 1702 from any combination of the peripheral devices 1706 or the databases 1708. Accordingly, the memory of the processors 1712, the memory/storage devices 1718, the peripheral devices 1706, and the databases 1708 are examples of computer-readable and machine-readable media.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc., as described above in connection with one or more of the preceding figures may be configured to operate in accordance with one or more of the examples set forth below in the example section.

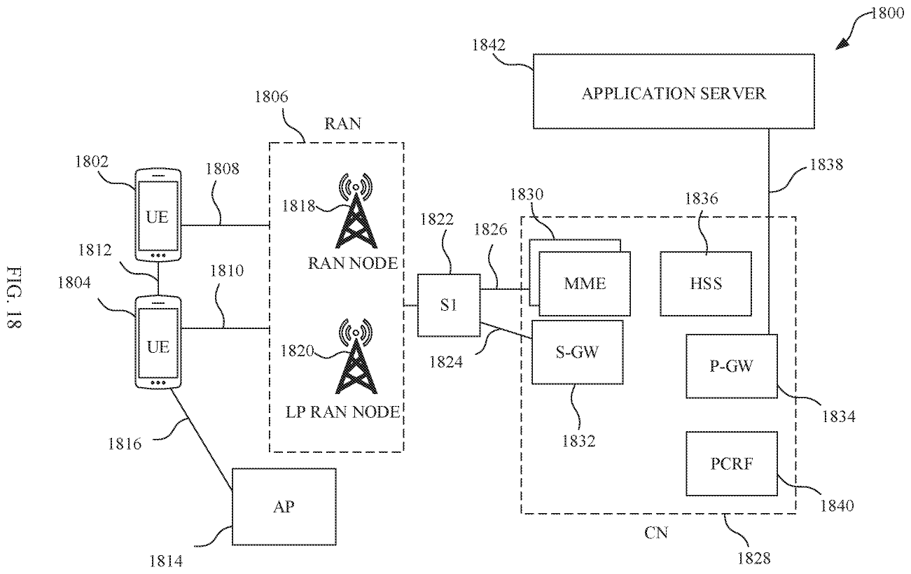

FIG. 18 illustrates an architecture of a system 1800 of a network in accordance with some embodiments. The system 1800 includes one or more user equipment (UE), shown in this example as a UE 1802 and a UE 1804. The UE 1802 and the UE 1804 are illustrated as smartphones (e.g., handheld touchscreen mobile computing devices connectable to one or more cellular networks), but may also comprise any mobile or non-mobile computing device, such as Personal Data Assistants (PDAs), pagers, laptop computers, desktop computers, wireless handsets, or any computing device including a wireless communications interface.

In some embodiments, any of the UE 1802 and the UE 1804 can comprise an Internet of Things (IoT) UE, which can comprise a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UE 1802 and the UE 1804 may be configured to connect, e.g., communicatively couple, with a radio access network (RAN), shown as RAN 1806. The RAN 1806 may be, for example, an Evolved ETniversal Mobile Telecommunications System (ETMTS) Terrestrial Radio Access Network (E-UTRAN), a NextGen RAN (NG RAN), or some other type of RAN. The UE 1802 and the LE 1804 utilize connection 1808 and connection 1810, respectively, each of which comprises a physical communications interface or layer (discussed in further detail below), in this example, the connection 1808 and the connection 1810 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UE 1802 and the UE 1804 may further directly exchange communication data via a ProSe interface 1812. The ProSe interface 1812 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 1804 is shown to be configured to access an access point (AP), shown as AP 1814, via connection 1816. The connection 1816 can comprise a local wireless connection, such as a connection consistent with any IEEE 802.11 protocol, wherein the AP 1814 would comprise a wireless fidelity (WiFi R) router. In this example, the AP 1814 may be connected to the Internet without connecting to the core network of the wireless system (described in further detail below).

The RAN 1806 can include one or more access nodes that enable the connection 1808 and the connection 1810. These access nodes (ANs) can be referred to as base stations (BSs), NodeBs, evolved NodeBs (eNBs), next Generation NodeBs (gNB). RAN nodes, and so forth, and can comprise ground stations (e.g., terrestrial access points) or satellite stations providing coverage within a geographic area (e.g., a cell) The RAN 1806 may include one or more RAN nodes for providing macrocells, e.g., macro RAN node 1818, and one or more RAN nodes for providing femtocells or picocells (e.g., cells having smaller coverage areas, smaller user capacity, or higher bandwidth compared to macrocells), e.g., a low power (LP) RAN node such as LP RAN node 1820.

Any of the macro RAN node 1818 and the LP RAN node 1820 can terminate the air interface protocol and can be the first point of contact for the UE 1802 and the UE 1804. In some embodiments, any of the macro RAN node 1818 and the LP RAN node 1820 can fulfill various logical functions for the RAN 1806 including, but not limited to, radio network controller (RNC) functions such as radio bearer management, uplink and downlink dynamic radio resource management and data packet scheduling, and mobility management.

In accordance with some embodiments, the EGE 18412 and the EGE 1804 can be configured to communicate using Orthogonal Frequency-Division Multiplexing (OFDM) communication signals with each other or with any of the macro RAN node 1818 and the LP RAN node 1820 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can comprise a plurality of orthogonal sub carriers.

In some embodiments, a downlink resource grid can be used for downlink transmissions from any of the macro RAN node 1818 and the LP RAN node 1820 to the UE 1802 and the UE 1804, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements Each resource block comprises a collection of resource elements; in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UE 1802 and the UE 1804. The physical downlink control channel (PDCCH) may carry information about the transport format and resource allocations related to the PDSCH channel, among other things. It may also inform the UE 1802 and the UE 1804 about the transport format, resource allocation, and H-ARQ (Hybrid Automatic Repeat Request) information related to the uplink shared channel. Typically, downlink scheduling (assigning control and shared channel resource blocks to the UE 1804 within a cell) may be performed at any of the macro RAN node 1818 and the LP RAN node 1820 based on channel quality information fed back from any of the UE 1802 and UE 1804. The downlink resource assignment information may be sent on the PDCCH used for (e.g., assigned to) each of the UE 1802 and the UE 1804.

The PDCCH may use control channel elements (CCEs) to convey the control information. Before being mapped to resource elements, the PDCCH complex-valued symbols may first be organized into quadruplets, which may then be permuted using a sub-block interleaver for rate matching Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition There can be four or more different PDCCH formats defined in LTE with different numbers of CCEs (e.g., aggregation level. L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs) Similar to above, each ECCE may correspond to nine sets of four physical resource elements known as enhanced resource element groups (EREGs). An ECCE may have other numbers of EREGs in some situations.

The RAN 1806 is communicatively coupled to a core network (CN), shown as CN 1828—via an S1 interface 1822. In embodiments, the CN 1828 may be an evolved packet core (EPC) network, a NextGen Packet Core (NPC) network, or some other type of CN. In this embodiment the S1 interface 1822 is split into two parts the S1-LU interface 1824, which carries traffic data between the macro RAN node 1818 and the LP RAN node 1820 and a serving gateway (S-GW), shown as S-GW 1832, and an S1-mobility management entity (MME) interface, shown as S1-MME interface 1826, which is a signaling interface between the macro RAN node 1818 and LP RAN node 1820 and the MME s) 18311.

In this embodiment, the CN 1828 comprises the MME(s) 1830, the S-GW 1832, a Packet Data Network (PDN) Gateway (P-GW) (shown as P-GW 1834), and a home subscriber server (HSS) (shown as HSS 1836). The MME(s) 1830 may be similar in function to the control plane of legacy Serving General Packet Radio Service (GPRS) Support Nodes (SGSN). The MME(s) 1830 may manage mobility aspects in access such as gateway selection and tracking area list management. The HSS 1836 may comprise a database for network users, including subscription-related information to support the network entities' handling of communication sessions. The CN 1828 may comprise one or several HSS 1836, depending on the number of mobile subscribers, on the capacity of the equipment, on the organization of the network, etc. For example, the HSS 1836 can provide support for routing/roaming, authentication, authorization, naming/addressing resolution, location dependencies, etc.

The S-GW 1832 may terminate the S1 interface 322 towards the RAN 1806, and routes data packets between the RAN 1806 and the CN 1828. In addition, the S-GW 1832 may be a local mobility anchor point for inter-RAN node handovers and also may provide an anchor for inter-3 GPP mobility Other responsibilities may include lawful intercept, charging, and some policy enforcement.

The P-GW 1834 may terminate an SGi interface toward a PDN. The P-GW 1834 may route data packets between the CN 1828 (e.g., an EPC network) and external networks such as a network including the application server 1842 (alternatively referred to as application function (AF)) via an Internet Protocol (IP) interface (shown as IP communications interface 1838). Generally, an application server 1842 may be an element offering applications that use IP bearer resources with the core network (e.g., ETMTS Packet Services (PS) domain, LTE PS data services, etc.). In this embodiment, the P-GW 1834 is shown to be communicatively coupled to an application server 1842 via an IP communications interface 1838. The application server 1842 can also be configured to support one or more communication services (e.g., Voice-over-Internet Protocol (VoIP) sessions, PTT sessions, group communication sessions, social networking services, etc.) for the UE 1802 and the UE 18414 via the CN 1828.

The P-GW 1834 may further be a node for policy enforcement and charging data collection. A Policy and Charging Enforcement Function (PCRF) (shown as PCRF 1840) is the policy and charging control element of the CN 1828. In a non-roaming scenario, there may be a single PCRF in the Home Public Land Mobile Network (HPLMN) associated with a ETE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN) The PCRF 1840 may be communicatively coupled to the application server 1842 via the P-GW 1834. The application server 1842 may signal the PCRF 184′) to indicate a new service flow and select the appropriate Quality of Service (QoS) and charging parameters. The PCRF 1840 may provision this rule into a Policy and Charging Enforcement Function (PCEF) (not shown) with the appropriate traffic flow template (TFT) and QoS class of identifier (QC), which commences the QoS and charging as specified by the application server 1842.

### ADDITIONAL EXAMPLES

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc., as described above in connection with one or more of the preceding figures may be configured to operate in accordance with one or more of the examples set forth below in the example section.

The following examples pertain to further embodiments
Example 1 is a method for a network, comprising: determining quality of service (QoS) information for a plurality of data flows with different QoS attributes, transmitting, to a user equipment (UE), a configuration message generated based on the QoS information, wherein the configuration message includes configuration information for at least one configured grant (CG); and receiving, from the UE based on the at least one CG, uplink data based on the plurality of data flows.
Example 2 is the method of Example 1, wherein the plurality of data flows includes a first data flow and a second data flow, and the QoS information indicates that the first data flow is mapped to a first logical channel (LCH) and the second data flow is mapped to a second LCH which is different from the first LCH, and wherein the at least one CG includes a first CG and a second CG which is different from the first CG, and the configuration information indicates that the first LCH is configured to be transmitted based on the first CG, and the second LCH is configured to be transmitted based on the second CG.
Example 3 is the method of Example 1, wherein the plurality of data flows includes a first data flow and a second data flow, and the QoS information indicates that the first data flow is mapped to a first QoS flow and the second data flow is mapped to a second QoS flow, and wherein the at least one CG includes a first CG and a second CG which is different from the first CG, and the configuration information indicates that the first QoS flow is configured to be transmitted based on the first CG, and the second QoS flow is configured to be transmitted based on the second CG.
Example 4 is the method of Example 3, wherein the plurality of data flows further includes a third data flow and the QoS information indicates that the third data flow is mapped to a third QoS flow which is different from the first QoS flow, and wherein the third QoS flow is configured to be transmitted based on the first CG.
Example 5 is the method of Example 3 or 4, wherein the QoS information indicates that the first QoS flow and the second QoS flow are mapped to a same logical channel (LCH).
Example 6 is the method of any one of Examples 3-5, further comprising, receiving buffer status report (BSR) from the UE, wherein the BSR includes a first buffer size for the first QoS flow and a second buffer size for the second QoS flow, respectively.
Example 7 is the method of Example 1, wherein the plurality of data flows includes a first data flow and a second data flow, and the QoS information indicates that the first data flow is mapped to a first internet protocol (IP) flow and the second data flow is mapped to a second IP flow which is different from the first IP flow, and wherein the at least one CG includes a first CG and a second CG which is different from the first CG, and the configuration information indicates that the first IP flow is configured to be transmitted based on the first CG, and the second IP flow is configured to be transmitted based on the second CG.
Example 8 is the method of Example 7, wherein the QoS information further indicates that first IP flow and the second IP flow are mapped to a same QoS flow.
Example 9 is the method of any one of Examples 1-8, wherein a first occasion of a first CG is configured to support a first transport block (TB) size, and a second occasion of the first CG is configured to support a second TB size which is different from the first TB size.
Example 10 is the method of Example 9, wherein the configuration information indicates the first TB size for the first occasion and the second TB size for the second occasion in an explicit manner.
Example 11 is the method of Example 9, wherein the configuration information indicates that each occasion of the first CG supports a set of TB sizes.
Example 12 is the method of Example 11, wherein the receiving, from the UE based on the at least one CG, uplink data based on the plurality of data flows includes: receiving, from the UE, a TB including the uplink data and uplink control information (UCI) indicating an actual size of the TB being transmitted based on the first CG, wherein the actual size of the TB is selected from the set of TB size indicated in the configuration information, determining the actual size of the TB based on the UCI; and decoding the TB based on the actual size.
Example 13 is the method of any one of Examples 1-12, wherein the determining quality of service (QoS) information for a plurality of data flows with different QoS attributes includes: receiving, from the UE, suggestion information regarding the QoS information for the plurality of data flows; and determining the QoS information for the plurality of data flows based on the suggestion information.
Example 14 is the method of Example 13, wherein the suggestion information is received by the core network CN) or a base station.
Example 15 is the method of any one of Examples 1-12, wherein the determining quality of service (QoS) information for a plurality of data flows with different QoS attributes includes: determining, by a core network (CN), the suggestion information regarding the QoS information for the plurality of data flows via an application server; and informing a base station about the suggestion information.
Example 16 is a method of a user equipment (UE, comprising: receiving, from a network, a configuration message, wherein the configuration message includes configuration information for at least one configured grant (CG) and is determined based on quality of service (QoS) information for a plurality of data flows with different QoS attributes; and generating, for transmission to the network based on the at least one CG, uplink data based on the plurality of data flows.
Example 17 is the method of Example 16, wherein the plurality of data flows includes a first data flow and a second data flow, and the QoS information indicates that the first data flow is mapped to a first logical channel (LCH) and the second data flow mapped to a second LCH which is different from the first LCH, and wherein the at least one CG includes a first CO and a second CG which is different from the first CG, and the configuration information indicates that the first LCH is configured to be transmitted based on the first CG, and the second LCH is configured to be transmitted based on the second CG.
Example 18 is the method of Example 16, wherein the plurality of data flows includes a first data flow and a second data flow, and the QoS information indicates that the first data flow is mapped to a first QoS flow and the second data flow mapped to a second QoS flow, and wherein the at least one CG includes a first CG and a second CG which is different from the first CG, and the configuration information indicates that the first QoS flow is configured to be transmitted based on the first CG, and the second QoS flow is configured to be transmitted based on the second CG.
Example 19 is the method of Example 18, wherein the plurality of data flows further includes a third data flow and the QoS information indicates that the third data flow is mapped to a third QoS flow which is different from the first QoS flow, and wherein the third QoS flow is configured to be transmitted based on the first CG.
Example 20 is the method of Example 18 or 19, wherein the QoS information indicates that the first QoS flow and the second QoS flow are mapped to a same logical channel (LCH).
Example 21 is the method of any one of Examples 16-20, further comprising: generating buffer status report (BSR) for transmission to the network, wherein the BSR includes a first buffer size for the first QoS flow and a second buffer size for the second QoS flow, respectively.
Example 22 is the method of Example 16, wherein the plurality of data flows includes a first data flow and a second data flow, and the QoS information indicates that the first data flow is mapped to a first internet protocol (IP) flow and the second data flow is mapped to a second IP flow which is different from the first IP flow, and wherein the at least one CG includes a first CG and a second CG which is different from the first CG, and the configuration information indicates that the first IP flow is configured to be transmitted based on the first CG, and the second IP flow is configured to be transmitted based on the second CG.
Example 23 is the method of Example 22, wherein the QoS information further indicates that first IP flow and the second IP flow are mapped to a same QoS flow.
Example 24 is the method of any one of Examples 16-23, wherein a first occasion of a first CG is configured to support a first transport block (TB) size, and a second occasion of the first CG is configured to support a second TB size which is different from the first TB size.
Example 25 is the method of Example 24, wherein the configuration information indicates the first TB size for the first occasion and the second TB size for the second occasion in an explicit manner.
Example 26 is the method of Example 24, wherein the configuration information indicates that each occasion of the first CG supports a set of TB sizes.
Example 27 is the method of Example 26, wherein the generating, for transmission to the network based on the at least one CO, uplink data based on the plurality of data flows includes: generating a transport block including the uplink data to be transmitted based on the first CG and uplink control information (UC) indicating an actual size of the TB, wherein the actual size of the TB is selected from the set of TB size indicated in the configuration information.
Example 28 is the method of any one of Examples 16-27, further comprising: generating suggestion information, for transmission to the network, regarding the QoS information for the plurality of data flows.
Example 29 is the method of Example 28, wherein the suggestion information is transmitted to the core network (CN) or a base station.
Example 30 is an apparatus for a network, the apparatus comprising: one or more processors configured to perform steps of the method according to any of Examples 1-15.
Example 31 is an apparatus for a user equipment (UE), the apparatus comprising: one or more processors configured to perform steps of the method according to any of Examples 16-29.
Example 32 is a computer readable medium having computer programs stored thereon which, when executed by one or more processors of an apparatus, cause the apparatus to perform steps of the method according to any of Examples 1-29.
Example 33 is a computer program product comprising computer programs which, when executed by one or more processors of an apparatus, cause the apparatus to perform steps of the method according to any of Examples 1-29.

Any of the above described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

It should be recognized that the systems described herein include descriptions of specific embodiments. These embodiments can be combined into single systems, partially combined into other systems, split into multiple systems or divided or combined in other ways. In addition, it is contemplated that parameters/attributes/aspects/etc. of one embodiment can be used in another embodiment. The parameters/attributes/aspects/etc., are merely described in one or more embodiments for clarity, and it is recognized that the parameters/attributes/aspects/etc., can be combined with or substituted for parameters/attributes/etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1.-33. (canceled)

34. A method comprising:
determining quality of service (QoS) information for a plurality of data flows with different QoS attributes;
transmitting, to a user equipment (UE), a configuration message generated based on the QoS information, wherein the configuration message includes configuration information for at least one configured grant (CG); and
receiving, from the UE based on the at least one CG, uplink data based on the plurality of data flows.

35. The method of claim 34, wherein:
the plurality of data flows includes a first data flow and a second data flow, and the QoS information indicates that the first data flow is mapped to a first logical channel (LCH) and the second data flow is mapped to a second LCH that is different from the first LCH; and
the at least one CG includes a first CG and a second CG that is different from the first CG, and the configuration information indicates that the first LCH is configured to be transmitted based on the first CG, and the second LCH is configured to be transmitted based on the second CG.

36. The method of claim 34, wherein:
the plurality of data flows includes a first data flow and a second data flow, and the QoS information indicates that the first data flow is mapped to a first QoS flow and the second data flow is mapped to a second QoS flow;
the at least one CG includes a first CG and a second CG that is different from the first CG, and the configuration information indicates that the first QoS flow is configured to be transmitted based on the first CG, and the second QoS flow is configured to be transmitted based on the second CG; and
the QoS information indicates that the first QoS flow and the second QoS flow are mapped to a same logical channel (LCH).

37. The method of claim 36, wherein:
the plurality of data flows further includes a third data flow and the QoS information indicates that the third data flow is mapped to a third QoS flow that is different from the first QoS flow; and
the third QoS flow is configured to be transmitted based on the first CG.

38. The method of claim 36, further comprising:
receiving buffer status report (BSR) from the UE, wherein the BSR includes a first buffer size for the first QoS flow and a second buffer size for the second QoS flow, respectively.

39. The method of claim 34, wherein:
the plurality of data flows includes a first data flow and a second data flow, and the QoS information indicates that the first data flow is mapped to a first internet protocol (IP) flow and the second data flow is mapped to a second IP flow that is different from the first IP flow; and
the at least one CG includes a first CG and a second CG that is different from the first CG, and the configuration information indicates that the first IP flow is configured to be transmitted based on the first CG, and the second IP flow is configured to be transmitted based on the second CG.

40. The method of claim 34, wherein:
a first occasion of a first CG is configured to support a first transport block (TB) size, and a second occasion of the first CG is configured to support a second TB size that is different from the first TB size; and
the configuration information indicates the first TB size for the first occasion and the second TB size for the second occasion in an explicit manner.

41. The method of claim 34, wherein:
a first occasion of a first CG is configured to support a first transport block (TB) size, and a second occasion of the first CG is configured to support a second TB size that is different from the first TB size;
the configuration information indicates that each occasion of the first CG supports a set of TB sizes; and
the receiving, from the UE based on the at least one CG, uplink data based on the plurality of data flows includes:
receiving, from the UE, a TB including the uplink data and uplink control information (UCI) indicating an actual size of the TB being transmitted based on the first CG, wherein the actual size of the TB is selected from the set of TB size indicated in the configuration information;
determining the actual size of the TB based on the UCI; and
decoding the TB based on the actual size.

42. The method of claim 34, wherein the determining QoS information for a plurality of data flows with different QoS attributes includes:
receiving, from the UE, suggestion information regarding the QoS information for the plurality of data flows; and
determining the QoS information for the plurality of data flows based on the suggestion information.

43. The method of claim 34, wherein the determining QoS information for a plurality of data flows with different QoS attributes includes:
determining, by a core network (CN), suggestion information regarding the QoS information for the plurality of data flows via an application server; and
informing a base station about the suggestion information.

44. One or more non-transitory, computer-readable media having instructions that, when executed, cause a user equipment (UE) to:
receive, from a network, a configuration message that includes configuration information for at least one configured grant (CG) and is determined based on quality of service (QoS) information for a plurality of data flows with different QoS attributes; and
generate, for transmission to the network based on the at least one CG, uplink data based on the plurality of data flows.

45. The one or more non-transitory, computer-readable media of claim 44, wherein:
the plurality of data flows includes a first data flow and a second data flow, and the QoS information indicates that the first data flow is mapped to a first logical channel (LCH) and the second data flow mapped to a second LCH that is different from the first LCH; and
the at least one CG includes a first CG and a second CG that is different from the first CG, and the configuration information indicates that the first LCH is configured to be transmitted based on the first CG, and the second LCH is configured to be transmitted based on the second CG.

46. The one or more non-transitory, computer-readable media of claim 44, wherein:
the plurality of data flows includes a first data flow and a second data flow, and the QoS information indicates that the first data flow is mapped to a first QoS flow and the second data flow mapped to a second QoS flow; and
the at least one CG includes a first CG and a second CG that is different from the first CG, and the configuration information indicates that the first QoS flow is configured to be transmitted based on the first CG, and the second QoS flow is configured to be transmitted based on the second CG.

47. The one or more non-transitory, computer-readable media of claim 46, wherein:
the plurality of data flows further includes a third data flow and the QoS information indicates that the third data flow is mapped to a third QoS flow which is different from the first QoS flow; and
the third QoS flow is configured to be transmitted based on the first CG.

48. The one or more non-transitory, computer-readable media of claim 46, wherein the QoS information indicates that the first QoS flow and the second QoS flow are mapped to a same logical channel (LCH).

49. The one or more non-transitory, computer-readable media of claim 46, wherein the instructions, when executed, further cause the UE to:
generate a buffer status report (BSR) for transmission to the network, wherein the BSR includes a first buffer size for the first QoS flow and a second buffer size for the second QoS flow, respectively.

50. The one or more non-transitory, computer-readable media of claim 44, wherein:
the plurality of data flows includes a first data flow and a second data flow, and the QoS information indicates that the first data flow is mapped to a first internet protocol (IP) flow and the second data flow is mapped to a second IP flow which is different from the first IP flow;
the at least one CG includes a first CG and a second CG that is different from the first CG, and the configuration information indicates that the first IP flow is configured to be transmitted based on the first CG, and the second IP flow is configured to be transmitted based on the second CG; and
the QoS information further indicates that first IP flow and the second IP flow are mapped to a same QoS flow.

51. The one or more non-transitory, computer-readable media of claim 44, wherein a first occasion of a first CG is configured to support a first transport block (TB) size, and a second occasion of the first CG is configured to support a second TB size which is different from the first TB size.

52. The one or more non-transitory, computer-readable media of claim 51, wherein the configuration information indicates the first TB size for the first occasion and the second TB size for the second occasion in an explicit manner.

53. The one or more non-transitory, computer-readable media of claim 44, wherein the instructions, when executed, further cause the UE to:
generate suggestion information, for transmission to the network, regarding the QoS information for the plurality of data flows.
